(19) United States
(12) Patent Application Publication
(10) Pub. No.: US 2012/0161894 A1
(43) Pub. Date: Jun. 28, 2012

(54) POWER DISTRIBUTION NETWORK FOR ENHANCING SIGNAL QUALITY

(75) Inventor: Jong Hwa KWON, Daejeon (KR)

(73) Assignee: ELECTRONICS AND TELECOMMUNICATIONS RESEARCH INSTITUTE, Daejeon (KR)

(21) Appl. No.: 13/332,805

(22) Filed: Dec. 21, 2011

(30) Foreign Application Priority Data
Dec. 23, 2010 (KR) 10-2010-0133925

(51) Int. Cl. H04B 3/28

(52) U.S. Cl. 333/12

(57) ABSTRACT

A power distribution network includes a reference plane placed under a signal line, the reference plane having a discontinuous structure; and a return current path for the signal line, the return current path being formed on the reference plane. The return current path has any one shape among the same shape as the signal line, a proportional shape to the signal line and an expansion shape of the signal line.

### CROSS-REFERENCE(S) TO RELATED APPLICATION(S)

The present invention claims priority of Korean Patent Application No. 10-2010-0133925, filed on Dec. 23, 2010, which is incorporated herein by reference.

### FIELD OF THE INVENTION

The present invention relates to a power distribution network; and, more particularly, to a power distribution network, such as a multilayered PCB (Printed Circuit Board) or a package, having a non-continuous reference layer, where the signal characteristics is improved by minimizing the adverse effect induced by the non-continuous reference layer.

### BACKGROUND OF THE INVENTION

Recently, on the worldwide level, a variety of wired/wireless communication services have been developed and become commercially available to realize “smart” era, not only ubiquitous era. Thus, advanced IT (Information Technology) devices and multimedia devices are increasingly used so as to process and transmit a huge amount of data required by such communication services. Those devices configured to process and transmit such huge amount of data are required to have a data processing and transmitting speed in the order of Giga bps or faster, and, thus, employ the clocks in the order of Giga Hertz or more in most cases. Further, it is prevailing trend that, for the sake of consumer satisfaction, multiple functionalities are integrated into a single electric/electronic device; for example, a multimedia device, such as a Smartphone and handset, integrates a MP3 player, an electronic dictionary and a camera, and home appliances, such as a refrigerator and a microwave oven, have Internet connectivity. This trend also requires fast processing and wide-band transmission.

As the clock frequency of several GHz is used as discussed above, signal/power integrity (SI/PI) and EMI (Electromagnetic Interference) problems, which are affected by SSN (Simultaneous Switching Noise) induced in the multilayered PCB or package, are one of the most important issues in designing system package and PCB for a high-speed system.

Generally, a pair of a power layer and a ground layer, which constitute a power distribution network (PDN), is placed in the multilayered PCB or package structure, forming a parallel plate waveguide. In this multilayered PCB and package structure where high speed signal is employed, a noise may arises in the PDN consisting of a power and a ground layers due to the placement layers, signal flow, and high-speed switching elements such as IC chips.

In order to suppress the noises such as common mode current and unnecessary electromagnetic wave, a decoupling capacitor or embedded capacitor is employed, possible with the split plane technology. However, this approach is effective only in a limited area of a substrate, and in a narrow frequency band below GHz order to make this approach inapplicable to high-speed systems operating in GHz frequency band.

Recently, the coplanar electromagnetic band gap (coplanar EBG) structure has been proposed to suppress noises in GHz band, where the unit cells having periodic structure are placed on the power or gourd layer by etching process or the like. However, this approach is not satisfactory also because the signal line passing over the reference layer of discontinuous structure is adversely affected, resulting in deterioration of the signal characteristics and circuit and system performance.

In case of a flexible multilayered PCB, where the power layer and/or the ground layer is formed with a lattice structure to improve its physical characteristic, the signal is affected by the discontinuous reference plane of the lattice structure.

One of the solutions generally used for compensating the adversary effect on the signal by the discontinuous reference layer is the differential signal line structure. In the differential signal line structure, the signals with the same amplitude but opposite phases (i.e., phase difference of 180 degree) are transmitted via a differential pair of signal lines so that the difference between the signals is transmitted. This provides a virtual reference layer between the signal lines, and the effect of the discontinuous reference layer is reduced, improving the signal characteristics.

However, the current electric/electronic devices, which employ high-speed wideband signal, are configured to have smaller size and lower power consumption and integrate multiple functionalities to meet the market demand. Further, because there are included in the device many signal lines for high-speed signal such as clock and data signals, it is difficult to apply the differential signal line structure to every important signal lines. In addition, at the end of the differential pair, if employed, signal loss may occur during mode conversion.

A power layer structure with embedded electromagnetic band gap structure has also been proposed for suppressing the effects caused by a single layer electromagnetic band gap structure, which is employed for reducing noise transfer in the power or ground layer of the multilayered PCB structure. However, such structure requires additional ground layer for embedding the power layer with the electromagnetic band gap structure to increase production cost and complicate process.

### SUMMARY OF THE INVENTION

In view of the above, the present invention provides a power distribution network, such as a multilayered PCB or a package, having a non-continuous reference layer, in which the signal characteristics is improved by minimizing the adverse effect induced by the non-continuous reference layer, while maintaining the original purpose of the non-continuous reference layer.

In accordance with an embodiment of the present invention, there is provided a power distribution network, including:

a reference plane placed under a signal line, the reference plane having a discontinuous structure; and

a return current path for the signal line, the return current path being formed on the reference plane.

### BRIEF DESCRIPTION OF THE DRAWINGS

The objects and features of the present invention will become apparent from the following description of embodiments, given in conjunction with the accompanying drawings, in which:

FIG. 1 illustrates signal flow and noise generation in a multilayered PCB or package employing high-speed signal of the prior art;

FIG. 2A shows a reference plane with split plane structure of the prior art;

FIG. 2B shows a reference plane with EBG structure of the prior art;

FIG. 2C shows a reference plane with lattice structure of the prior art;

FIG. 3 shows a reference plane with EBG structure, in which a return current path is formed in accordance with an embodiment of the present invention;

FIG. 4A shows a cross-section of a PDN in accordance with one embodiment of the present invention;

FIG. 4B shows a reference plane with a return current path, having a discontinuous structure in accordance with one embodiment of the present invention;

FIG. 4C shows a reference plane with a return current path, having a full EBG (FEBG) structure in accordance with another embodiment of the present invention;

FIG. 4D shows a reference plane with a return current path, having a partial EBG (PEBG) structure in accordance with yet another embodiment of the present invention;

FIGS. 5A to 5C show plots of Simultaneous Switching Noise obtained by simulation of exemplary planes;

FIG. 6 shows a plot of signal transmission characteristics obtained by simulation of exemplary planes; and

FIG. 7 shows a reference plane with a return current path, having a lattice structure in accordance with one embodiment of the present invention.

### DETAILED DESCRIPTION OF THE EMBODIMENTS

Hereinafter, embodiments of the present invention will be described with reference to the accompanying drawings which form a part hereof.

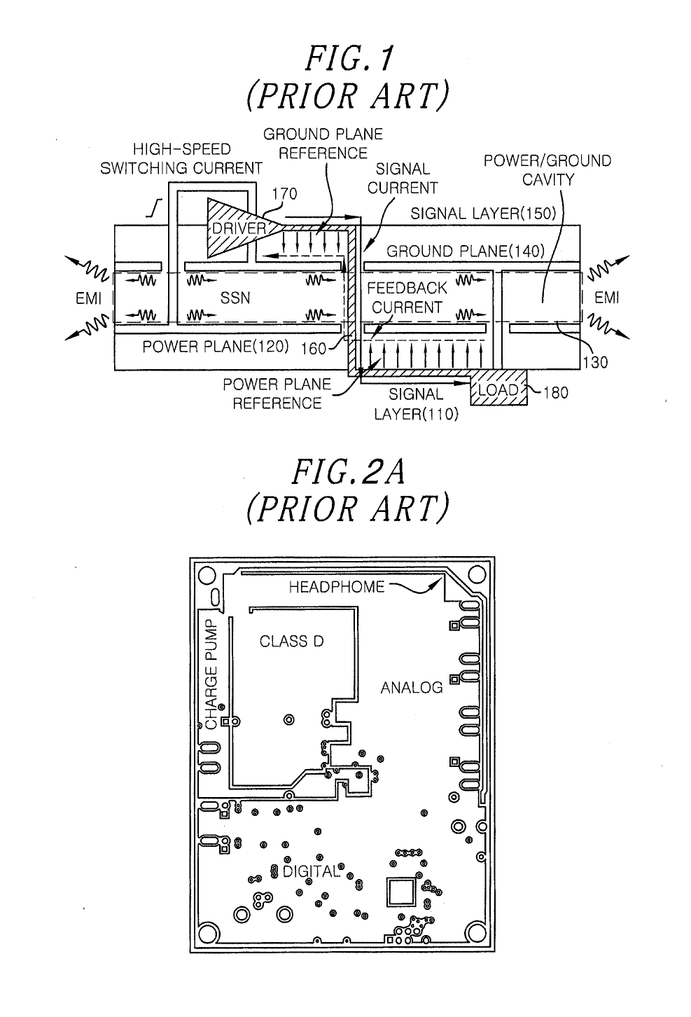

FIG. 1 illustrates signal flow and noise generation in a multilayered PCB or package employing high-speed signal of the prior art. As shown in FIG. 1, the multilayered PCB or package of the prior art includes a ground plane 140 and a power plane 120. Signal layers 110 and 150 are formed on the power plane 120 and the ground plane 140, respectively. A high-speed switching element such as IC (integrated circuit) chip 170 is placed on the signal layer 150, and a load element 180 is placed on the signal layer 110, with an interconnection 160 connecting them. Between the power plane 120 and the ground plane 140, a substrate 130 is placed.

Due to the operation of the IC chip and high-speed signal employed thereby, noise is generated in the parallel transmission line formed by the ground plane and the power plane. For example, EMI noise is generated at the ends of the parallel transmission line.

While the signal is transmitted through signal layers 110 and 150 and interconnection 160, a return current is generated and transmitted through the ground plane. However, when the frequency of the signal is high, the return current may be transmitted through any current path which has relatively low impedance, and, thus, both of the ground plane and the power plane may be the return current path. If the power plane or the ground plane has discontinuous structure, the return current may not be transmitted effectively therethrough to deteriorate the signal characteristics. For example, in FIG. 1, the ground plane 140 is split into three sections, and the power plane 120 into three sections in order to suppress noise or unnecessary electromagnetic wave. However, this causes a discontinuity in the power and/or ground plane to adversarially affects the signal. In another example, EBG structure may also cause such discontinuity in the power and/or ground plane.

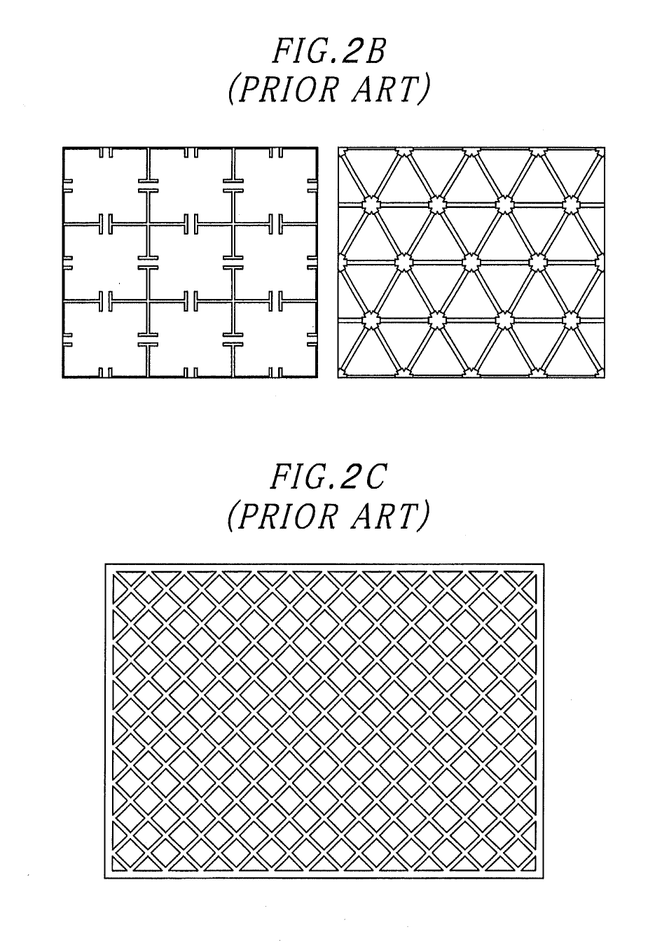

FIGS. 2A to 2C show example reference plane of the prior art. The reference plane of FIG. 2A employs the split plane technology, whereby the plane is split into several sections. The reference planes in FIGS. 2B and 2C have EBG structure and lattice structure, respectively. These types of reference planes have discontinuity, failing to provide a sufficient path for return currents.

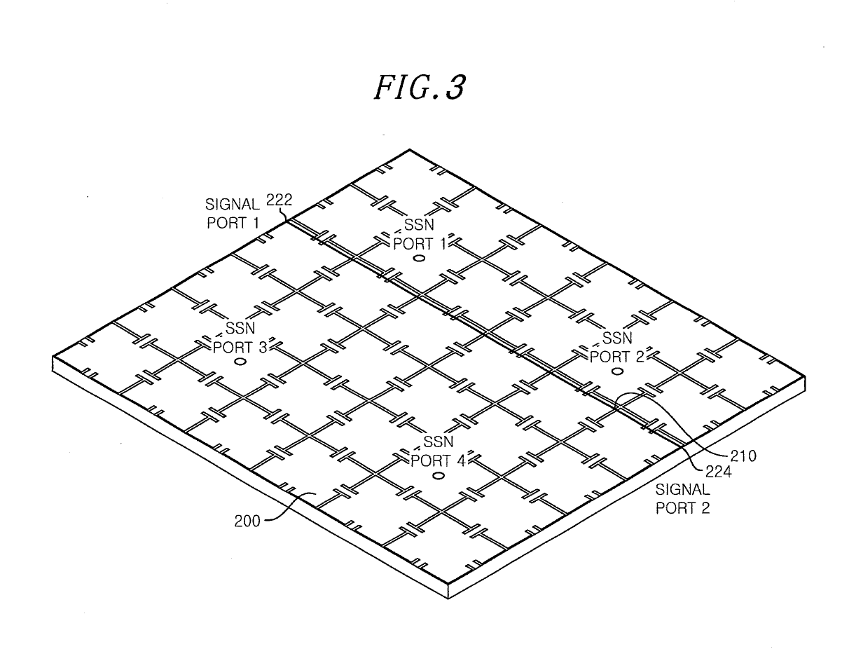

FIG. 3 shows a reference plane, which may be included in a PDN, in accordance with an embodiment of the present invention. The reference plane 200 includes EBG structure for reducing common mode current or unnecessary electromagnetic wave, which introduces discontinuity to the plane. The reference plane 200 would be, if included in a PDN, placed under the signal line (not shown) between the signal port 222 and the signal port 224.

The plane 200 has a return current path 210 for the signal path. The return current path 210 may have the same shape as the signal line. Alternatively, the return current path 210 may have the shape, which is proportional to the shape of the signal line, or an expansion of the signal line to provide more secure path for the return current.

The EBG and/or split plane structure sufficiently reduces the noise and unnecessary electromagnetic wave in a particular frequency band while deteriorating the signal due to lack of sufficient return current path. The present invention minimizes the deterioration of the signal, for example, by providing a return current path 210.

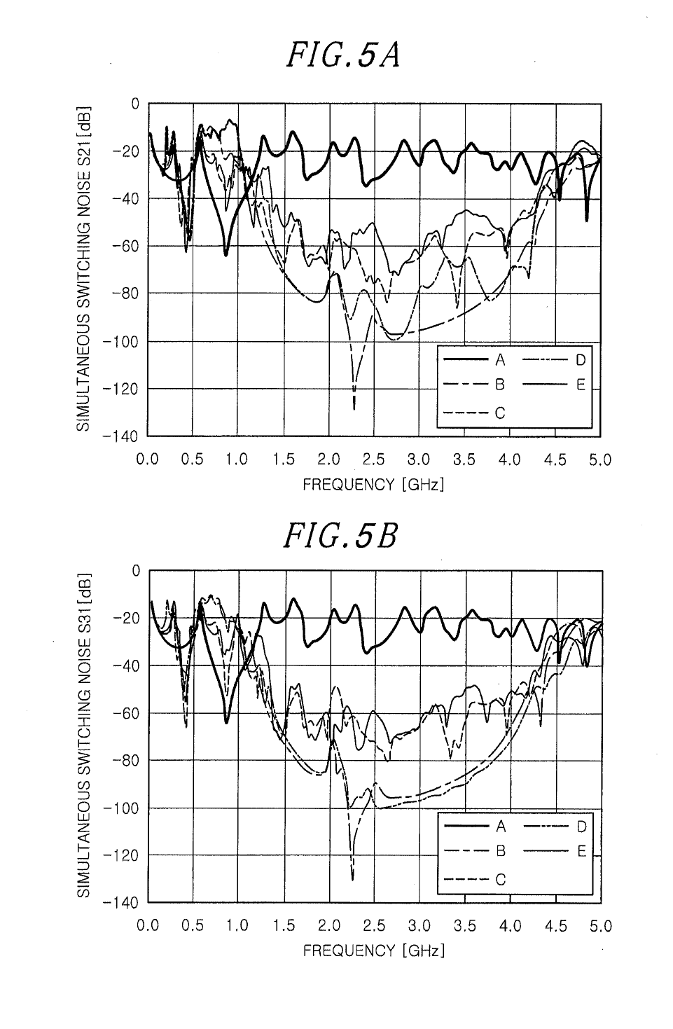

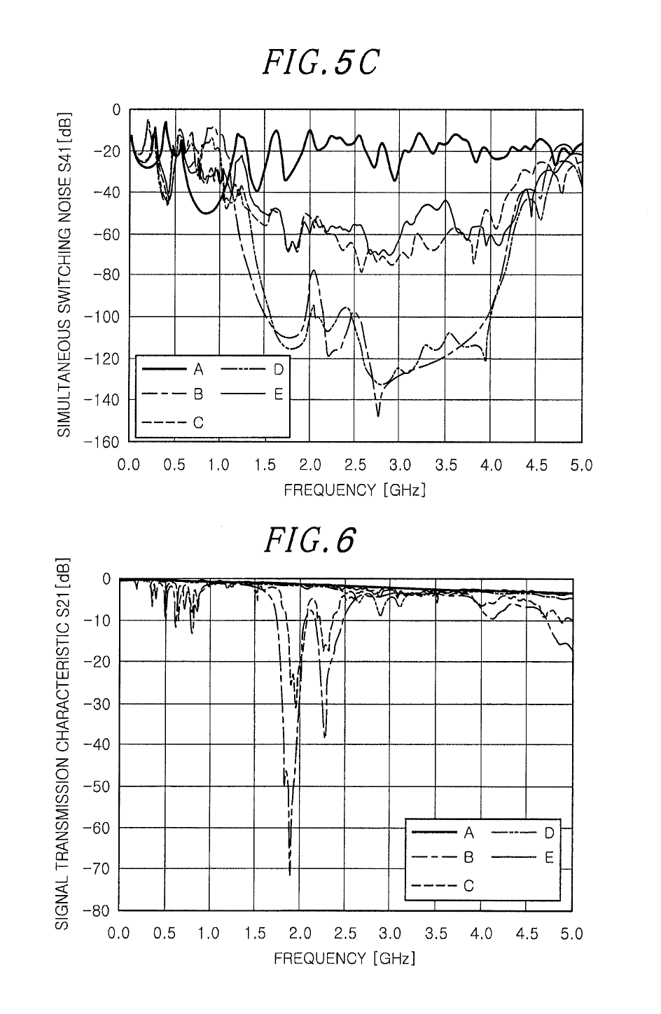

FIG. 3 also shows SSN ports 1 to 4, which will be discussed below with respect to FIG. 5A to 5C.

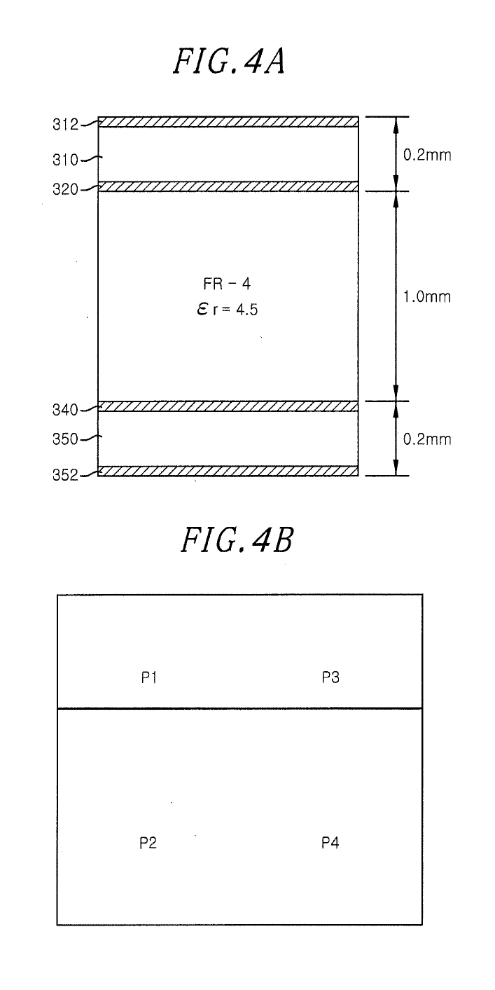

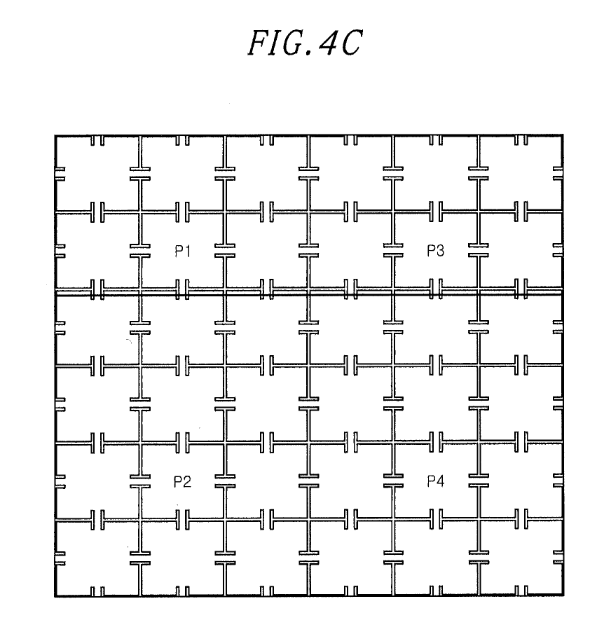

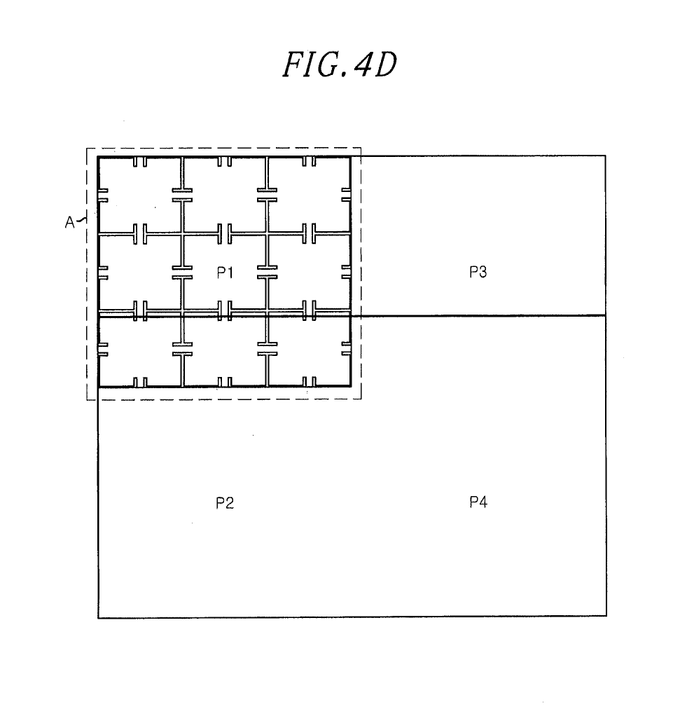

FIG. 4A to 4D show PDNs used in simulation for verifying the advantageous effect of the present invention. FIG. 4A shows a cross-section of a PDN in accordance with one embodiment of the present invention. Similar to the structure shown in FIG. 1, the PDN includes the signal plane 310, power plane 320, and ground plane 340, and a substrate 330 is interposed between the power and ground planes 320 and 340. In one embodiment, the power and ground planes 320 and 340 may be formed on the surfaces of the substrate 330, for example, by etching process. The substrate 330 may be FR-4 substrate with dielectric constant ∈ᵣ=4.5. Further, in one embodiment, signal line 312 may be formed on the signal layer 310, for example, by etching process.

Although an additional signal plane 350 and signal line 352 may also be included in the PDN in one embodiment, the plane 350 was not included in the PDN used in simulation.

In one exemplary example used in the simulation, the thickness of signal layer 310 was 0.2 mm, and the thickness of the substrate 330 was 1.0 mm. The signal layer 350, if included, may have the same thickness as signal layer 310.

FIG. 4B shows a reference plane having a discontinuous structure, and FIG. 4C shows a reference plane having a full EBG (FEBG) structure, where the entire plane having the EBG structure. FIG. 4D shows a reference plane having a partial EBG (PEBG) structure, i.e., the EBG structure is applied only in area ‘A’ of the plane. The simulation was conducted using ANSYS HFSS™, which commercially available from ANSYS, Inc. of Canonsburg, Pa., U.S.A.

FIGS. 5A to 5C show plots of Simultaneous Switching Noise (SSN) measured at each of the SSN ports shown in FIG. 1 during the simulation of one embodiment of the present invention. FIG. 5A shows SSN between port 1 and port 2 (S21), FIG. 5B shows SSN between port 1 and port 3 (S31), and FIG. 5C shows SSN between port 1 and port 4 (S41).

In FIGS. 5A to 5C, line A is for a bare board (i.e., without EBG or return current path), line B is for FEBG board, line C is for PEBG board, line D is for FEBG board with a return current formed, and line E is for PEBG board with a return current formed. As is apparent from FIGS. 5A to 5C, the noise suppression achieved by the split plane technology or EBG technology has been little affected by the addition of the return current path.

FIG. 6 shows a plot of signal transmission characteristics obtained by simulation. In FIG. 6, line A is for a bear board, line B is for a FBEG board, line C is for a PEBG board. Further, lines D and E are for a FBEG board and a PEBG board, respectively, on which the return current path in accordance with one embodiment of the present invention is formed. As shown in FIG. 6, comparing line A with lines B and C, if EBG structure is fully or partially formed in a board, it can be seen that the discontinuity introduced to the board deteriorates the signal transmission characteristics. However, comparing line A with lines D and E, if the return current path is formed, the signal transmission characteristics are substantially identical to that of the bear board. That is, the return current path of the embodiment of the present invention improves the signal transmission characteristics while maintaining the noise reduction effect of EBG structure.

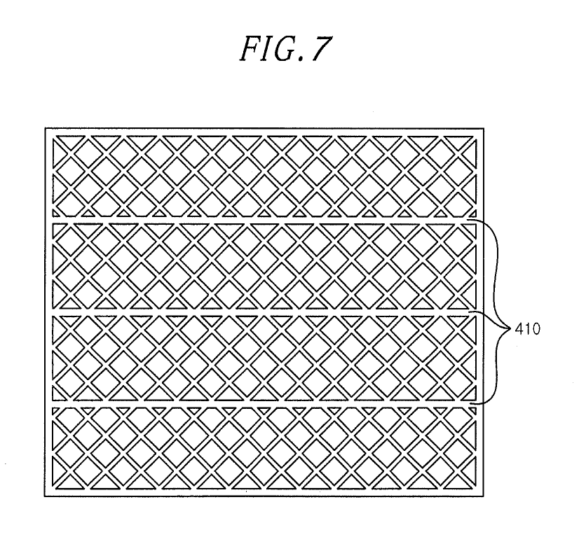

FIG. 7 shows a reference plane with a return current path, having a lattice structure in accordance with one embodiment of the present invention. As shown in FIG. 7, in accordance with one embodiment of the present invention, the return current path 410 may be formed in the reference plane having a lattice structure. In one embodiment, two or, more return current paths may be formed in the reference plane. In such case, improvement in the signal characteristics may increase.

As described above, in accordance with embodiments of the present invention, by providing a return current path on the discontinuous reference plane in a PDN such as multilayered PCB or package, it is possible to minimize the effect of the discontinuous reference plane on the signal characteristics, while maintaining noise reduction achieved by the discontinuous reference plane.

Further, such return current path may be formed on a reference plane having a lattice structure, where the lattice structure may improve the physical reliability of the reference plane if applied in a flexible PCB.

Further, the conventional technique such as differential signal line structure may be employed together with the return current path to further improve the signal characteristics.

While the invention has been shown and described with respect to the embodiments, it will be understood by those skilled in the art that various changes and modification may be made without departing from the scope of the invention as defined in the following claims.

What is claimed is:

1. A power distribution network, comprising:
a reference plane placed under a signal line, the reference plane having a discontinuous structure; and
a return current path for the signal line, the return current path being formed on the reference plane.

2. The power distribution network of claim 1, wherein the return current path has any one shape among the same shape as the signal line, a proportional shape to the signal line and an expansion shape of the signal line.

3. The power distribution network of claim 1, wherein the reference plane is a power plane or a ground plane in a printed circuit board or a package.

4. The power distribution network of claim 2, wherein the reference plane is a power plane or a ground plane in a printed circuit board or a package.

5. The power distribution network of claim 1, wherein said discontinuous structure includes a single layer electromagnetic band gap structure.

6. The power distribution network of claim 1, wherein the reference plane is a power plane or a ground plane in a printed circuit board or a package, which is split to suppress a transfer of common mode current therethrough.

7. The power distribution network of claim 2, wherein the reference plane is a power plane or a ground plane in a printed circuit board or a package, which is split to suppress a transfer of common mode current therethrough.

8. The power distribution network of claim 1, wherein the reference plane is a power plane or a ground plane in a printed circuit board, which has a lattice structure to improve physical characteristics thereof.

9. The power distribution network of claim 2, wherein the reference plane is a power plane or a ground plane in a printed circuit board, which has a lattice structure to improve physical characteristics thereof.
